(19) United States
(12) Patent Application Publication
(10) Pub. No.: US 2025/0224224 A1
(43) Pub. Date: Jul. 10, 2025

(54) POSITION SENSOR

(71) Applicant: Honeywell International Inc., Charlotte, NC (US)

(72) Inventors: Nithin Ramesh L, Charlotte, NC (US); Shridhara SHANBHOGUE, Charlotte, NC (US); Alex WANG, Charlotte, NC (US); M Vijaya Kumar REDDY, Charlotte, NC (US); Kumaran NARASIMHAN, Charlotte, NC (US); Suresh S, Charlotte, NC (US); Sudhakar AROCKIARAJ, Charlotte, NC (US); Anukrishnan KARAKATTIL, Charlotte, NC (US)

(21) Appl. No.: 19/088,422

(22) Filed: Mar. 24, 2025

Related U.S. Application Data
(63) Continuation of application No. 17/305,635, filed on Jul. 12, 2021.

(30) Foreign Application Priority Data
Jul. 16, 2020 (CN) 202010685853.9

(51) Int. Cl. G01B 7/30; E02F 9/26; F02D 41/26; G01C 9/02; G01C 19/00; G01D 5/14; G01P 15/00; H04Q 9/00

(52) U.S. Cl. CPC G01B 7/30; E02F 9/26; F02D 41/26; G01C 9/02; G01C 19/00; G01D 5/145; G01P 15/00; H04Q 9/00; H04Q 2209/30

(57) ABSTRACT

A sensor assembly for a position sensor is provided. The sensor assembly comprises a data sensor and a communication sensor. The data sensor has a first printed circuit board and the first printed circuit board has a plurality of sensor elements disposed on a first side of the first printed circuit board. The first printed circuit board has a swing angle sensing unit and an inclination sensing unit. The communication sensor is electrically connected to the data sensor. The communication sensor has a second printed circuit board. The second printed circuit board is aligned such that the second printed circuit board faces a second side of the first printed circuit board.

### CROSS-REFERENCE TO RELATED APPLICATIONS

This application is a continuation of U.S. Non-Provisional application Ser. No. 17/305,635, filed Jul. 12, 2021, which claims priority pursuant to 35 U.S.C. 119 (a) to China Patent Application No. 202010685853.9, filed Jul. 16, 2020, each of which is incorporated herein by reference in its entirety.

### TECHNOLOGICAL FIELD

Example embodiments of the present disclosure relate generally to position sensors, and more particularly, to a position sensor for detecting a change in position of a rotatable component of a heavy machine.

### BACKGROUND

Position sensors are generally used in heavy machines, such as cranes, excavators, dozers, and forklifts to detect a change in position of rotatable or movable components of the machines. The change in position of a rotatable component is required for smooth and seamless operation of heavy machines and movement of the heavy machines from an initial position to a target position. The change in position is determined in terms of an angular movement of a rotatable component along different axes.

Generally, separate position sensors are used for measuring different angular movements, such as a swing angle and an inclination angle of a cabin or a chassis of the heavy machines. Data collected by the position sensors for different angular movements are sent through separate packets and buses to an Engine Control Unit (ECU) for reporting and analysis. The analysis of multiple packets sent through different buses to determine the change in position is complicated and prone to errors.

### BRIEF SUMMARY

The illustrative embodiments of the present disclosure relates to a sensor assembly for a position sensor. The sensor assembly includes a data sensor and a communication sensor. The data sensor has a first printed circuit board. The first printed circuit board has a plurality of sensor elements disposed on a first side of the first printed circuit board. The first printed circuit board has a swing angle sensing unit and an inclination sensing unit. The communication sensor is electrically connected with the data sensor. The communication sensor has a second printed circuit board.

In an example embodiment, the second printed circuit board faces a second side of the first printed circuit board.

In an example embodiment, the inclination sensing unit of the sensor assembly comprises a mems sensor.

In an example embodiment, the inclination sensing unit is electrically connected with at least one of a gyroscope and an accelerometer.

In an example embodiment, the sensor assembly comprises a first housing defining a cavity, wherein the data sensor and the communication sensor are disposed within the cavity.

In an example embodiment, the swing angle sensing unit is configured to detect at least one of a yaw rotation angle and a roll angle of a cabin of a vehicle.

In an example embodiment, the communication sensor comprises a Controller Area Network (CAN) transceiver to receive data from the data sensor.

In an example embodiment, the communication sensor further comprises a filter.

In some embodiments, a sensor assembly for a position sensor comprises a first housing defining a cavity, a data sensor disposed within the cavity of the first housing, and a communication sensor electrically connected to the data sensor. The data sensor has a first printed circuit board, wherein the first printed circuit board has a plurality of sensor elements disposed on a first side of the first printed circuit board. The first printed circuit board has a swing angle sensing unit and an inclination sensing unit. The communication sensor comprises a second printed circuit board, wherein the communication sensor is disposed within the cavity, and wherein the second printed circuit board faces a second side of the first printed circuit board.

In an example embodiment, the sensor assembly is electrically connected to an Engine Control Unit (ECU).

In some embodiments, the inclination sensing unit comprises a mems sensor.

In an example embodiment, the sensor assembly further comprises a connector disposed within the cavity of the first housing.

In an example embodiment, the swing angle sensing unit detects at least one of a yaw rotation angle and a roll angle of a cabin of a heavy machine.

In an example embodiment, a position sensor for detecting swing and inclination for a cabin of a heavy machine is provided. The position sensor comprises a first housing defining a cavity, a data sensor disposed within the cavity of the first housing, a communication sensor electrically connected to the data sensor, a second housing, and a magnet. The data sensor comprises a first printed circuit board, wherein the first printed circuit board has a plurality of sensor elements disposed on a first side of the first printed circuit board, wherein the first printed circuit board comprises a swing angle sensing unit and an inclination sensing unit. The communication sensor comprises a second printed circuit board, wherein the communication sensor is disposed within the cavity. The second housing is coupled to the first housing, wherein the second housing defines a first cavity. The magnet is rotatable about a rotational axis and is disposed within the first cavity of the second housing, wherein the magnet is coupled to the cabin and rotates in an instance when the cabin rotates, and wherein a first end of the magnet is disposed adjacent to the data sensor.

In an example embodiment, the second housing comprises a second cavity, wherein the first housing is disposed within the second cavity.

In some embodiments, the second printed circuit board faces a second side of the first printed circuit board.

In various embodiments, the inclination sensing unit comprises a mems sensor.

In an example embodiment, the swing angle sensing unit detects at least one of a yaw rotation angle and a roll angle of the cabin of the heavy machine.

In an example embodiment, the inclination sensing unit is electrically connected with at least one of a gyroscope and an accelerometer.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a heavy machine as an environment for implementing a position sensor, in accordance with an example embodiment of the present disclosure;

FIG. 2 illustrates an external view of a position sensor for detecting a change in position of a rotatable component, in accordance with an example embodiment of the present disclosure;

FIG. 3 is an exploded view of a position sensor, in accordance with an example embodiment of the present disclosure;

FIGS. 4-6 illustrate engagement between connectors and a first housing of a position sensor, in accordance with an example embodiment of the present disclosure;

FIG. 7 illustrates a second housing for a position sensor, in accordance with an example embodiment of the present disclosure;

FIGS. 8-10 illustrate a magnet and a magnetic liner of a position sensor, in accordance with an example embodiment of the present disclosure;

FIGS. 11 and 12 illustrate a data sensor and a communication sensor, in accordance with an example embodiment of the present disclosure;

FIGS. 13 and 14 illustrate an external ring and an internal ring for sealing components of a position sensor, in accordance with an example embodiment of the present disclosure;

FIG. 15 illustrates a cross-sectional view of a position sensor, in accordance with an example embodiment of the present disclosure; and,

FIG. 16 illustrates a block diagram of printed circuit boards of communication and data sensors of a position sensor, in accordance with an example embodiment of the present disclosure.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The terms “or” and “optionally” are used herein in both the alternative and conjunctive sense, unless otherwise indicated. The terms “illustrative” and “exemplary” are used to be examples with no indication of quality level. Like numbers refer to like elements throughout.

The components illustrated in the figures represent components that may or may not be present in various example embodiments described herein such that embodiments may include fewer or more components than those shown in the figures while not departing from the scope of the disclosure.

Turning now to the drawings, the detailed description set forth below in connection with the appended drawings is intended as a description of various example configurations and is not intended to represent the only configurations in which the concepts described herein may be practiced. The detailed description includes specific details for the purpose of providing a thorough understanding of various concepts with like numerals denoting like components throughout the several views. However, it will be apparent to those skilled in the art of the present disclosure that these concepts may be practiced without these specific details.

In many example industrial working environments, such as mining, tunneling, quarrying, ship building, construction, heavy industry engineering industry, power industry, and forestry, heavy machines are used for, amongst other operations, transferring heavy goods from one point to another. These machines generally have multiple movable or rotatable components, such as arms, boom, bucket and cabin. During operation of the machines, the movement and change in position of these rotatable components is determined by a position sensor coupled to a rotatable component of the machines. Readings captured by the position sensor aids in determining that the machine is operating normally. Separate position sensors are used for detecting swing angle and inclination angle readings of the rotatable components of the machines. To this end, some existing position sensors may not be efficient in capturing accurate readings of the angular movements of the rotatable components due to separate sensors being used for detecting different angular movements.

Various example embodiments described in the present disclosure relate to a position sensor and a sensor assembly of the position sensor for detecting a change in position of a rotatable component of heavy machines. The position sensor has two housings, a first housing and a second housing. The first housing and the second housing have cavities to receive components of the position sensor. For example, a data sensor and a communication sensor are disposed within a cavity of the first housing. The data sensor is configured to capture data related to swing angle and inclination angle of the rotatable component and the communication sensor is to convert the captured data into a communication packet for sending the data packet to an Engine Control Unit (ECU) for processing.

In the second housing, a magnet is disposed within a cavity of the second housing. The magnet is disposed in the cavity of the second housing such that the magnetic field of the magnet links the data sensor that is disposed within the cavity of the first housing. The magnet is rotatable along a rotational axis and is coupled to the rotatable component. In an instance, when the rotatable component rotates, the magnet rotates along its rotational axis. The rotation of the magnet causes a change in the magnetic field linking the data sensor. The change in the magnetic field is detected by the data sensor for determining an angular movement of the rotatable component.

The details regarding components of the position sensor and their working is described in detail with reference to subsequent figures and description.

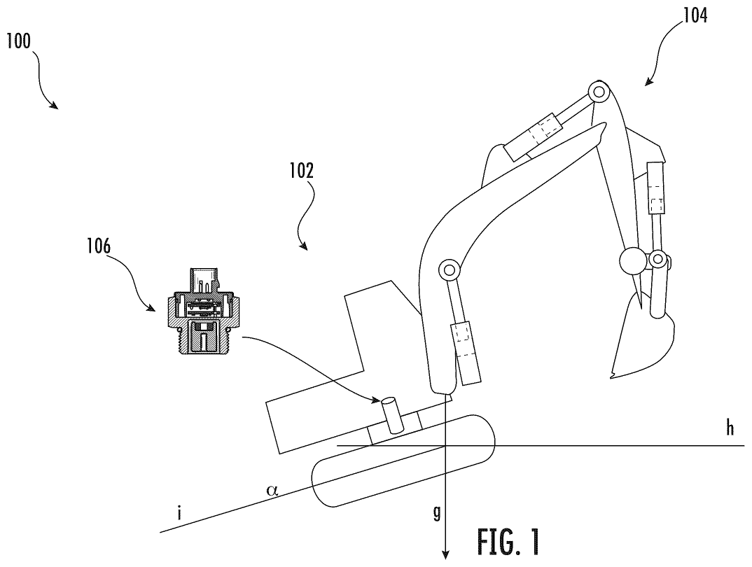

FIG. 1 illustrates a heavy machine 100 having a cabin 102 and an arm 104, in accordance with an example embodiment of the present disclosure. As shown, a position sensor 106 is implemented on the cabin 102 of the heavy machine 100. Examples of a heavy machine 100 may include excavators, bulldozers, loaders, backhoe loaders, cranes, and forklifts. The machines are used for performing heavy tasks such as transferring heavy loads from a first point to a second point. For operating the heavy machine 100, an operator sitting inside the cabin 102 interacts with a control panel provided in the cabin 102 and operates the arm 104 to perform a required task.

The heavy machine 100 has several moving components, such as the cabin 102 and the arm 104. The cabin 102 is rotatable along its axis and the arm 104 has movable components, such as a boom, a stick, and a bucket, where each component is rotatable along its rotational axis. During operation, position and alignment of each component with respect to each other and the ground is required for determining an initial alignment or position of the machine 100. The position and alignment, in one example, relates to a swing angle or a yaw rotation angle of a component, and an inclination or tilt of the heavy machine 100 with respect to a gravity plane. Based on the initial alignment, a target position or alignment is determined, and the machine 100 is operated to traverse a path from the initial position to the target position.

The swing angle may be understood as a rotation of the components along an axis in terms of a roll referring to a rotation along the x-axis, a pitch angle for a rotation along the y-axis, and a yaw rotation angle for a rotation along the z-axis. The inclination may be determined in terms of the angle of inclination between the component with respect to any one axis or all three axes and with respect to the ground, shown as a horizontal line. For instance, as shown in FIG. 1, when the heavy machine 100 is positioned on the ground 1, the inclination of the cabin 102 is a with respect to a horizontal plane h and the direction of gravity acting upon the cabin 102 is g.

In an example embodiment, the position sensor 106 is coupled to the cabin 102 of the heavy machine 100. In an example, the position sensor 106 includes Attitude Position Referencing Sensor (APRS). The position sensor 106 is coupled such that a rotatable component of the cabin 102 is attached to the position sensor 106 and is used to sense the rotation of the rotatable component. In an embodiment, the rotatable component is the cabin 102 that rotates with respect to wheels of the cabin 102. In one example, the position sensor 106 is coupled closer to the wheels of the heavy machine 100. Although shown as coupled to the cabin 102 of the heavy machine 100, it may be understood that in one embodiment, the position sensor 106 may be coupled to a swing assembly of the heavy machine 100.

In another example embodiment, the position sensor 106 may be coupled to one or more of the boom, the stick, or the bucket of the arm 104 of the machine 100. The position sensor 106 detects swing angle data and the inclination angle for the cabin 102. During operation of the machine 100, the position sensor 106 provides the data related to both the swing angle and the inclination angle. The data related to the swing angle and the inclination angle is filtered from noise and converted to one communication packet, for instance a Controller Access Network (CAN) packet and transmitted to an Engine Control unit (ECU). The ECU may then fetch the data from the communication packet and process the data to determine change in position of the rotatable component. In one example, the single communication packet is transmitted through a common bus. This reduces wiring included in the position sensor 106 and improves accuracy and processing time for position determination.

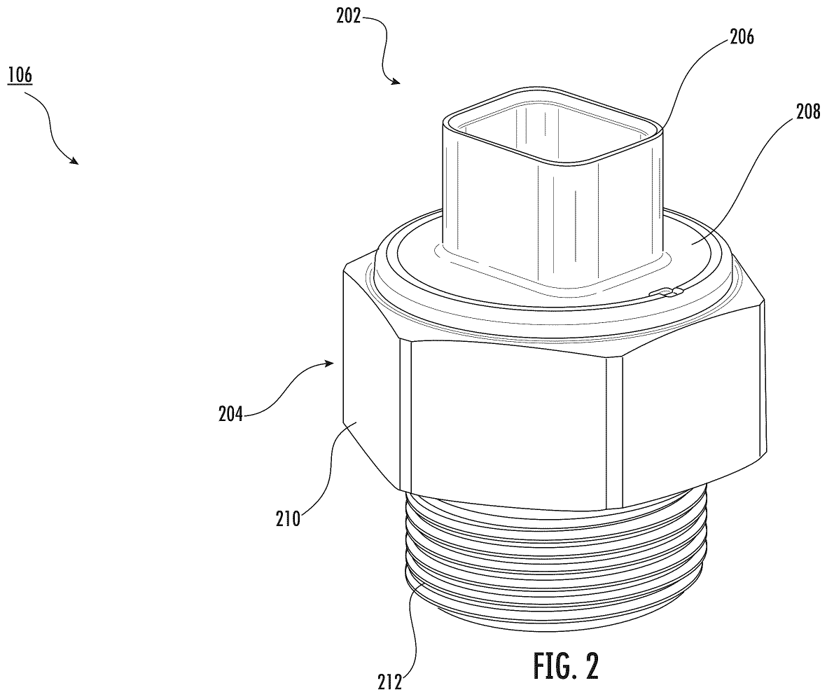

FIG. 2 illustrates an external view of the position sensor 106, in accordance with an example embodiment of the present disclosure. The position sensor 106 comprises a first housing 202 and a second housing 204. Both the first housing 202 and the second housing 204 may be composed of a plastic or metallic material. It would be understood that the shape and size of the first housing 202 and the second housing 204 shown in the figures may have a different shape based on the application and implementation of the position sensor 106 for the cabin 102.

In an example embodiment, the first housing 202 has a first portion 206 and a second portion 208. The first portion 206 is rectangular shaped, as shown. The first portion 206 also has a cavity to receive a connector within the cavity of the first portion 206. In an example, the size and shape of the cavity is varied based on the number and size of connectors disposed within the cavity of the first portion 206. In a case of a greater number of connectors, the cavity may be wider. For a lesser number of connectors, the cavity has a reduced size.

The second portion 208 has a circular shape and is composed of a plastic or metallic material. The shape of the second portion 208 is based on a shape of a sensor assembly housed within the second portion 208 of the first housing 202. The second portion 208 of the first housing 202 is disposed within a first cavity of the second housing 204. In one example, the second portion 208 is disposed by inserting the second portion 208 within the first cavity of the second housing 204. In yet another embodiment, the second portion 208 is threaded and is thread-mounted to the first cavity of the second housing 204. In another embodiment, the second portion 208 may be attached to the first cavity using an adhesive. The second portion 208 of the first housing 202 is housed within the first cavity of the second housing 204 such that the first housing 202 is secured to the second housing 204 as a unit.

The second housing 204 has two portions, a top portion 210 and a bottom portion 212. The top portion 210 has the first cavity and the bottom portion 212 has a second cavity. The first cavity, as described, houses the second portion 208 of the first housing 202. The top portion 210 has flat surface portions along an outer circumference of the top portion 210. For instance, the top portion 210 may be shaped to have six flat surface portions of a nut for easier installation.

The bottom portion 212, in an example, is a threaded portion for thread mounting the position sensor 106 onto a rotatable component or the cabin 102 of the heavy machine 100. Although shown as a threaded portion, the bottom portion 212 can also be a nonthreaded portion. For example, the bottom portion 212 may be shaped to snap fit-into a pocket of the cabin 102. In another example, the bottom portion 212 can be mechanically coupled to the cabin 102.

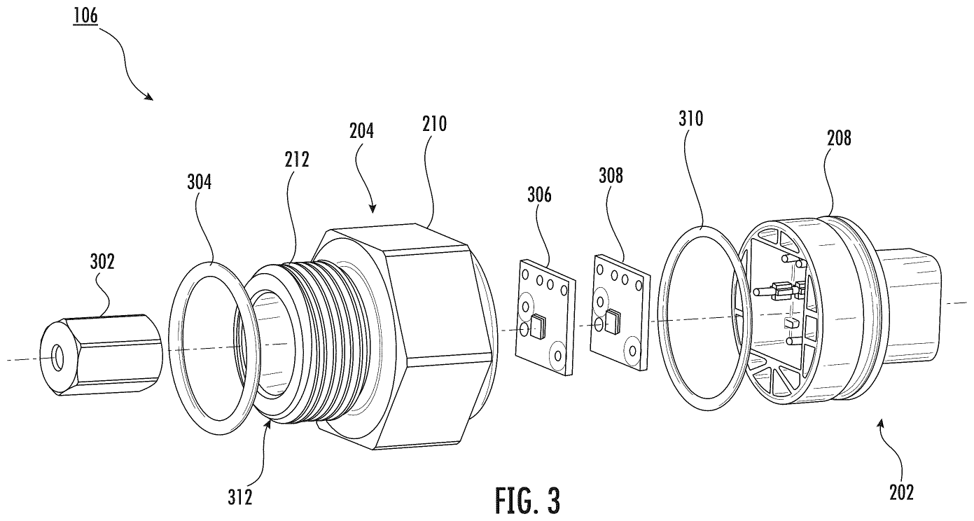

FIG. 3 is an exploded view of the position sensor 106, in accordance with an example embodiment of the present disclosure. As shown, the position sensor 106 comprises the first housing 202, the second housing 204, a magnetic liner 302, an external ring 304, a data sensor 306, a communication sensor 308, and an internal ring 310. The magnetic liner 302 is generally a hexagonal nut that houses a magnet. The magnetic liner 302 is rotatable along a rotational axis.

The magnetic liner 302 is coupled to the rotatable component of the cabin 102 such that in an instant when the rotatable component swings or rotates when the cabin 102 changes position or moves from one point to another, the magnetic liner 302 also rotates. In an example, the length and diameter of the magnetic liner 302 and the magnet housed within are predefined. The length and diameter may be defined based on magnitude of magnetic field of the magnet linking the data sensor 306. In another example, the length and diameter of the magnetic liner 302 and the magnet may be determined based on a distance between the magnet and the data sensor 306.

The second housing 204 has the first cavity, as previously described, to house the bottom portion 212 of the first housing 202. The second housing 204 also has a second cavity 312. In an assembled state, the magnetic liner 302 is disposed within the second cavity 312. The magnetic liner 302 is disposed such that there is a gap between the magnetic liner 302 and an inner wall of the second cavity 312 to allow rotation of the magnetic liner 302 within the second cavity 312 in an instant when the rotatable component of the cabin 102 rotates.

The external ring 304 is fitted on the bottom portion 212 of the second housing 204 at a point of connection of the top portion 210 and the bottom portion 212. The external ring 304 provides a proper fitting and sealing when the second housing 204 is coupled to the rotatable component of the cabin 102. In an example, the shape and size of the external ring 304 is varied based on the shape and size of the bottom portion 212 of the second housing 204. The second housing 204 has the first cavity. The data sensor 306 and the communication sensor 308 are housed within the first cavity of the second housing 204. The data sensor 306 is electrically connected with the communication sensor 308 through connectors. The data sensor 306 and the communication sensor 308 are aligned such that a first side of the data sensor 306 faces the magnetic liner 302 and the communication sensor 308 faces a second side of the data sensor 306. In an example, the data sensor 306 may include a sensor and controller module to detect data related to position and angle of the cabin 102 and the arm 104 and process the collected data.

The internal ring 310 is disposed on the top portion 210 of the second housing 204 such that the second housing 204 can be fitted and sealed against the first housing 202. The first housing 202 is disposed on the second housing 204 such that the second portion 208 is disposed within the first cavity of the second housing 204. In the assembled state, the data sensor 306 and the communication sensor 308 are encased by the second housing 204 from the bottom side and by the first housing 202 from the top side. The second portion 208 of the first housing 202 also has spacing for the connectors and input and output terminals to pass through and connect to an external circuit.

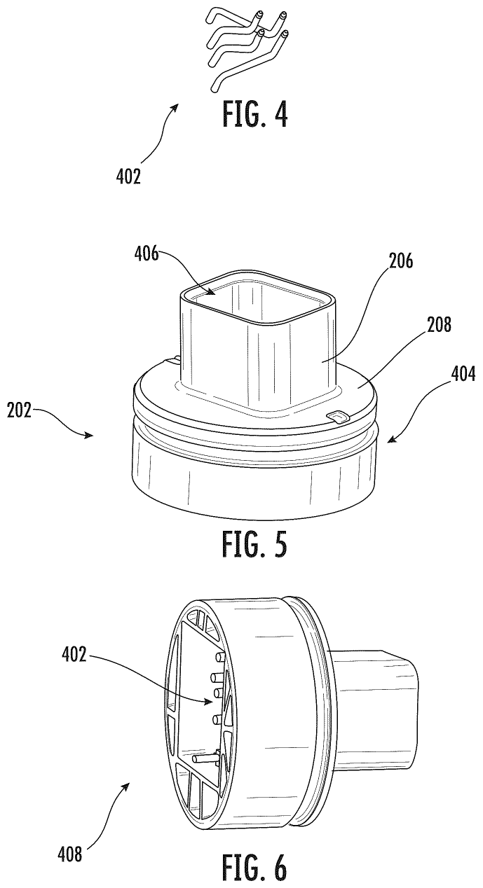

FIGS. 4-6 illustrate connectors 402 and the first housing 202 of the position sensor 106, in accordance with an example embodiment of the present disclosure. FIG. 4 shows the connectors 402 that are used for connecting the data sensor 306 and the communication sensor 308. The data sensor 306 and the communication sensor 308 have their inputs and outputs connected through the connectors 402. The connectors 402 may be understood as electrically conductive wires used for joining electrical terminals of the data sensor 306 and the communication sensor 308 and creating an electrical circuit. The connectors 402 may be removably attached to the data sensor 306 and the communication sensor 308 or serve as a permanent joint between two points. The connectors 402, in an example, are soldered to a first printed circuit board of the data sensor 306 and a second printed circuit board of the communication sensor 308. In another example, the connectors 402 are mounted on the first and second printed circuit board using pins, screws or board to board connectors. In an example embodiment, the connectors 402 are composed of copper and its alloys.

Referring to FIG. 5, the first housing 202 has the first portion 206 and the second portion 208. In one example, the first portion 206 and the second portion 208 are a single molded body. The first portion 206 is a plastic or metallic material. The first portion 206 is rectangular shaped, as shown. The first portion 206 can have any other suitable shape and has a cavity 406 to house the connectors 402. The size and shape of the cavity 406 is varied based on the number and size of connectors 402 disposed within the cavity 406 of the first portion 206.

The second portion 208 of the first housing 202 is disposed within the first cavity of the second housing 204. The second portion 208 is circular in shape. The shape of the second portion 208 is based on a shape of the sensor assembly housed within the first housing 202. In one example, the second portion 208 is inserted within the first cavity of the second housing 204. In yet another embodiment, the second portion 208 is threaded and is thread-mounted to the first cavity of the second housing 204. In another embodiment, the second portion 208 may be attached to the first cavity using an adhesive. In one example, the second portion 208 has a groove 404 on an outer surface along an outer circumference of the second portion 208. In an example, the groove 404 allows the first housing 202 to properly fit into the second housing 204 during assembly. FIG. 6 shows the connectors 402 disposed within a cavity 408 of the first housing 202. As shown, the cavity 408 is within the second portion 208 of the first housing 202. In one example, the cavity 406 and the cavity 408 are linked internally.

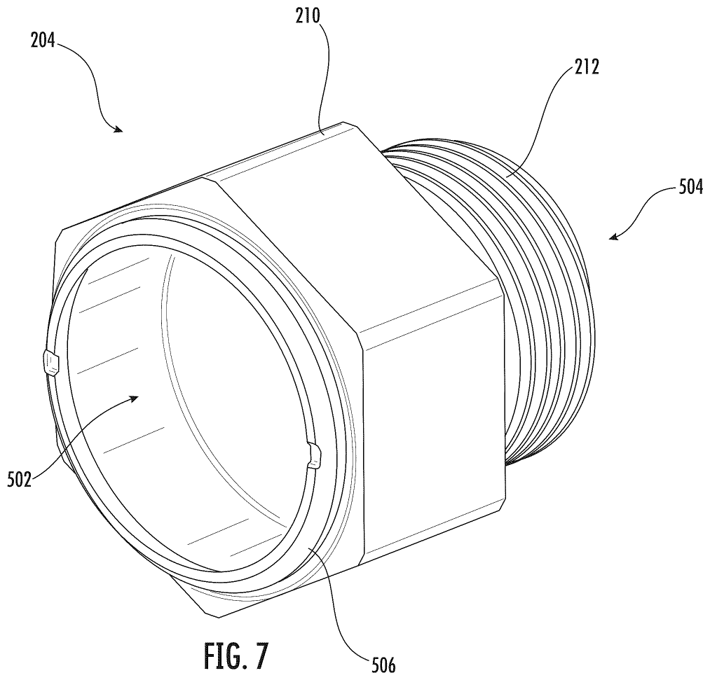

FIG. 7 illustrates the second housing 204, in accordance with an example embodiment of the present disclosure. The second housing 204 can be a plastic or metallic material. As described previously, the second housing 204 has two portions, a top portion 210 and a bottom portion 212. The top portion 210 has a first cavity 502 and the bottom portion 212 has a second cavity 504. The first cavity 502, as described, houses the second portion 208 of the first housing 202. The top portion 210 has one or more flat surfaces along an outer circumference of the top portion 210. As shown, the bottom portion 212 of the second housing 204 is a threaded portion for thread mounting the position sensor 106 onto the cabin 102 of the heavy machine 100. The bottom portion 212 is mounted onto the cabin 102. Although shown as a threaded portion, the bottom portion 212 can also be a nonthreaded portion that is snap fitted into a pocket of the cabin 102. In another example, the bottom portion 212 can be mechanically coupled to the cabin 102.

In an example, the top portion 210 has a raised portion 506. The raised portion 506 is of a circular shape and is disposed along a circumference of the first cavity 502. The raised portion 506 allows fitting of the first housing 202 into the second housing 204. In one example, an inner wall of the first cavity 502 may be a threaded portion for thread mounting of the first housing 202 into the second housing 204.

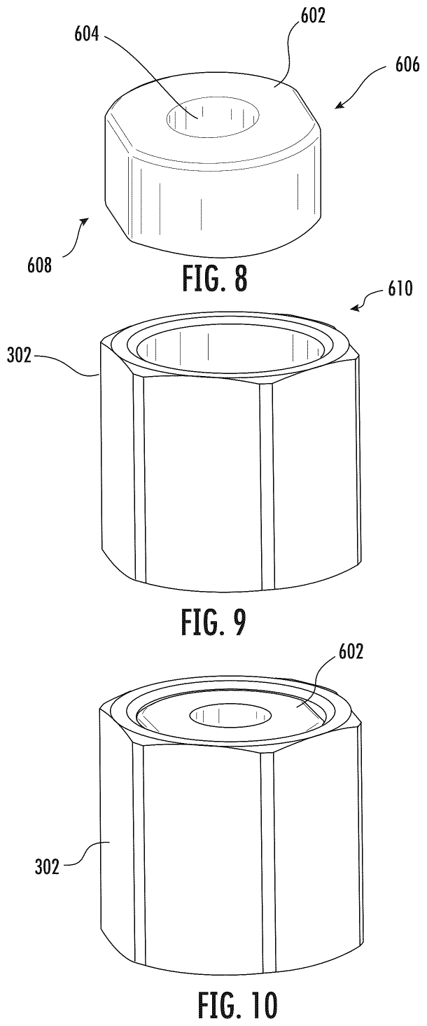

FIGS. 8-10 show a magnet 602, the magnetic liner 302, and the engagement between the magnet 602 and the magnetic liner 302, respectively. In an example, the magnet 602 is a permanent magnet. The shape and size of the magnet 602 is selected based on the magnitude of magnetic flux linking the data sensor 306, and the distance between the magnet 602 and the data sensor 306. The magnet 602, in one example, is circular shaped as shown with an aperture 604 at the center of the magnet 602. The magnet 602 also has two flat surfaces 606 and 608 positioned diametrically opposite to each other. The flat surfaces 606 and 608 provide polarization of magnetic axial plane and a gap between the flat surfaces 606 and 608 of the magnet 602 and an inner wall of the magnetic liner 302 that allows easy fitting of the magnet 602 into the magnetic liner 302. Further, the flat surfaces 606 and 608 also provide easy removal of the magnet 602 from the magnetic liner 302.

As shown in FIG. 10, the magnet 602 is disposed within a cavity 610 of the magnetic liner 302. FIG. 10 shows the magnet 602 placed within the magnetic liner 302. In one example, the magnet 602 is either snap fitted into the cavity 610 of the magnetic liner 302 or attached using an adhesive. The magnet 602 is disposed adjacent to a top end of the magnetic liner 302. In the assembled state, the top end of the magnetic liner 302 is positioned adjacent to the data sensor 306 that is disposed within the first housing 202. In one example, the magnetic liner 302 and the magnet 602 are coupled to the rotatable component of the cabin 102, such that upon rotation of the rotatable component, the magnetic liner 302 and the magnet 602 rotate.

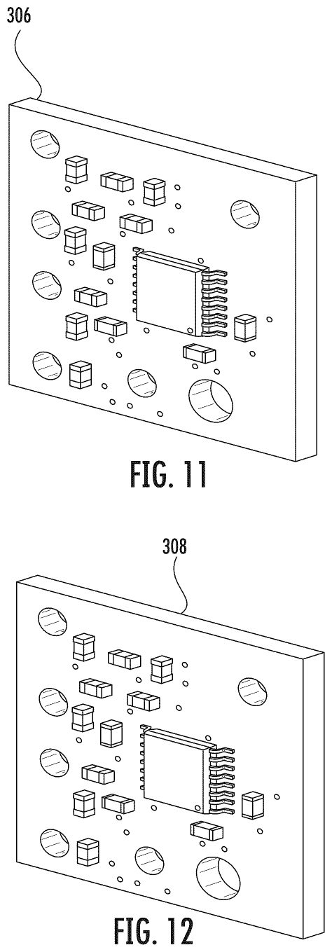

FIGS. 11 and 12 illustrate the data sensor 306 and the communication sensor 308, in accordance with the present disclosure. The data sensor 306 comprises a first Printed Circuit Board (PCB). The first PCB has hall sensors aligned on a first side of the first PCB. In one example, there are multiple hall sensors aligned with a predefined spacing between each other. The hall sensors detect the change in magnetic flux of the magnet 602 based on rotation of the magnet 602 and detect the change in position or angle of rotation of the rotatable component. The first PCB also comprises a swing angle sensing unit, a controller unit and an inclination angle sensing unit. The swing angle sensing unit detects yaw rotation of the magnet 602 which is mechanically integrated with the cabin 102 of a heavy machine and a change in voltage determined by the hall sensors in response to the rotation of the magnet 602. In an example embodiment, the inclination angle sensing unit is configured to detect pitch and roll angle of the cabin 102 with respect to ground plane. In an example embodiment, onboard Micro controller will condition the sensor data and filter the noises and provides outputs such as swing yaw angle position, cabin inclination pitch and roll angles.

The inclination angle sensing unit detects an inclination of the position sensor 106 when the cabin tilts or changes orientation with respect to the ground. In an example, the inclination angle sensing unit is electrically connected with a gyroscope and an accelerometer. The gyroscope and the accelerometer detect the inclination or change in position of the position sensor 106 and the inclination angle sensing unit retrieves this data from the gyroscope and the accelerometer. There may be machine vibrations captured by the accelerometer and the gyroscope that is compensated by a filter logic in the Micro controller.

The communication sensor 308 also comprises a second PCB. In the assembled state, the second PCB is aligned such that the second PCB faces a second side of the first PCB. Although shown as facing the second side of the first PCB, the communication sensor 308 may also be aligned in some other suitable manner, such as facing a side surface of the first PCB or positioned adjacent to the first PCB in one plane.

In an example, the second PCB converts the data detected by the data sensor 306 into communication packets, such as Controller Area Network (CAN) packets for sending the communication packets to an Engine Control Unit (ECU) of the heavy machine 100. For instance, the communication sensor 308 converts swing angle data and inclination angle data into a CAN packet. In an example, the communication sensor 308 converts both the swing angle data and the inclination angle data into one CAN packet. The second PCB then sends the packet to the ECU. In such an example, the ECU processes the CAN packet to retrieve information regarding both the swing angle data and the inclination angle data from the CAN packet.

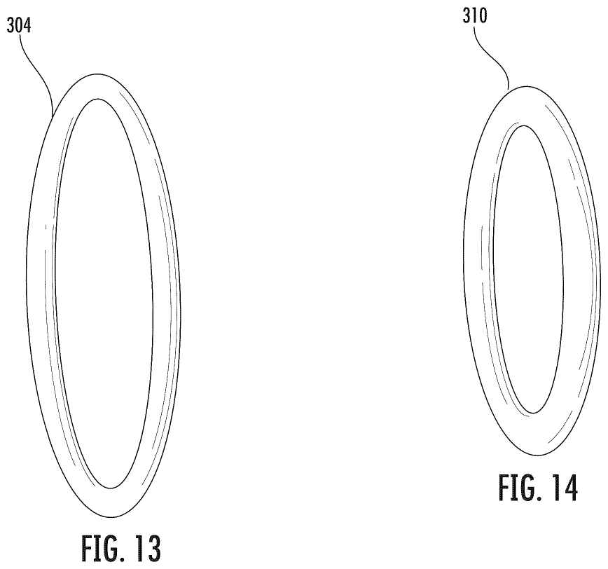

FIGS. 13 and 14 illustrate the external ring 304 and the internal ring 310 of the position sensor 106, in accordance with an example embodiment of the present disclosure. The external ring 304 and the internal ring 310 of the position sensor 106 are also referred to as the rings 304 and 310. The rings 304 and 310 are attached to the second housing 204 and the first housing 202, respectively. The rings 304 and 310 facilitate proper fitting of the second housing 204 to the cabin 102 and the first housing 202 to the second housing 204. The rings 304 and 310 may be understood as mechanical gaskets or a loop of pliable material with a disc-shaped cross-section.

In an example, the rings 304 and 310 are designed to be seated into grooves within the second housing 204 and the first housing 202. The rings 304 and 310 are compressed during assembly between two or more parts, creating a seal. For instance, the rings 304 and 310 are disposed between the second housing 204 and the cabin 102, and first housing 202 and the second housing 204. Such an arrangement reduces vertical displacements and vibrations caused when the position sensor 106 rotates or moves during operation.

Further, the rings 304 and 310 maintain sealing contact force by radial or axial deformation between the second housing 204 and the rotatable component, and the first housing 202 and the second housing 204.

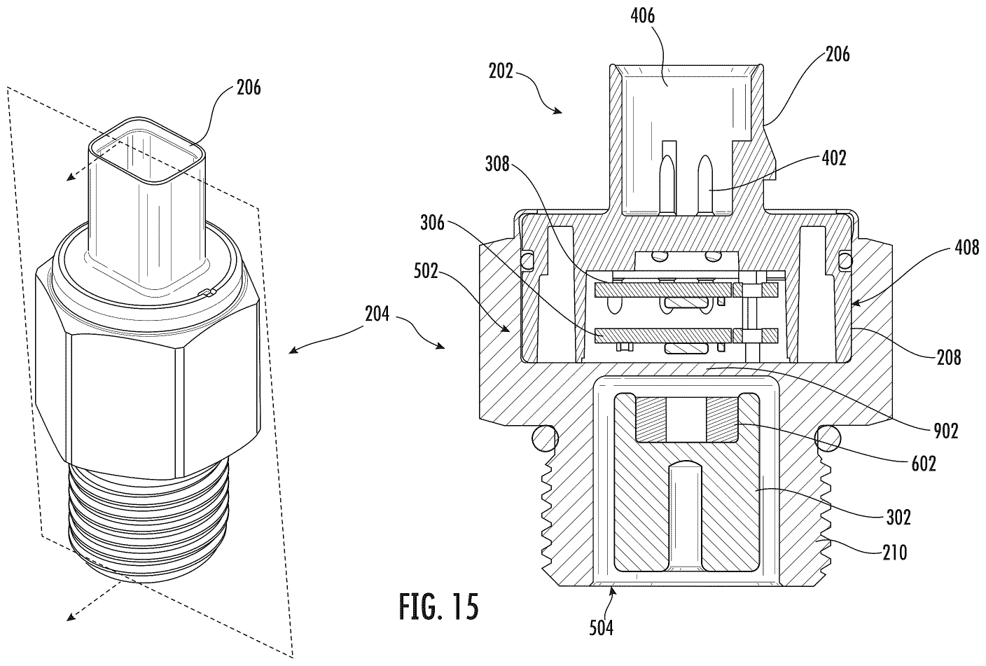

FIG. 15 illustrates a cross-sectional view of the position sensor 106, in accordance with an example embodiment of the present disclosure. As shown, the first housing 202 is engaged with the second housing 204. The second portion 208 of the first housing 202 is disposed within the first cavity 502. In an embodiment, the engagement of the first housing 202 and the second housing 204 may be different as shown in the figures. For instance, the first housing 202 may be attached to the second housing 204 on one surface, for example on a bottom side. In yet another example, the first housing 202 and the second housing 204 may be snap fitted with each other. In another embodiment, the first housing 202 and the second housing 204 may be integrated as one housing instead of two separate housings.

As described previously, the first housing 202 comprises the first portion 206 and the second portion 208. Both the first portion 206 and the second portion 208 have cavities, a first cavity 406 and a second cavity 408, where the cavities are interlinked. In an example, the first portion 206 may have a rectangular shape as shown. However, the first portion 206 can have other shapes, as discussed previously.

In one embodiment, the second portion 208 is circular shaped. The second portion 208 is disposed within the second housing 204. The second portion 208 may encase the sensors of the position sensor 106, as previously described. The second portion 208 is disposed within the first housing 202 such that the sensors 306 and 308 housed within the second portion 208 can interact with the magnet 602 of the second housing 204.

The second housing 204 has two cavities, a first cavity 502 and a second cavity 504, as previously described. The first cavity 502 is a cavity on a top side of the second housing 204 and is configured to house the second portion 208 of the first housing 202. The second cavity 504 is configured to house components such as the magnet 602. In an example, the second housing 204 has a bottom portion 212 that is threaded. The bottom portion 212 may be used, in one example, to fasten the position sensor 106 into a component of the cabin 102. In another example, the second housing 204 may be snap fitted into the component of the cabin 102. In one example, the second cavity 408 of the first housing 202 and the second cavity 504 of the second housing 204 may be separated by a wall 902 of the second housing 204.

The data sensor 306 is positioned in the second portion 208 of the first housing 202 such that the sensor elements, such as the hall sensors disposed on a first side of the first PCB, face the magnet 602. Each sensor element is spaced equally from each other. In one example, the sensor elements may have low resolution, having a lesser number of sensor elements with more spacing between each sensor element, or a high resolution, having a greater number of sensor elements having less space between the sensor elements. The alignment allows detection of a change in magnetic field of the magnet 602 by the sensor elements when the magnet 602 rotates. The communication sensor 308 is aligned such that the second PCB of the communication sensor 308 faces a second side of the first PCB. The first PCB and the second PCB are connected through the connectors 402.

In various embodiments, the position sensor 106 is electrically connected to an Application Specific Integrated Circuit (ASIC) (not shown in the figure). In various other embodiments, the position sensor 106 may be electrically connected to two or more ASICs based on configuration of the position sensor 106. In embodiments where two or more ASICs are used for processing data, one ASIC is used as master ASIC and the other ASICs work as slave ASICs. The slave ASICs receive communication packets from the communication sensor 308. In one example, the communication packets have data related to change in voltage output as detected by the data sensor 306. After receiving the data, the slave ASICs may process the data to determine change in position of the rotational component or the cabin 102. The master ASIC receives data from all the slave ASICs and computes the final value of swing angle change and an inclination angle change for the cabin 102.

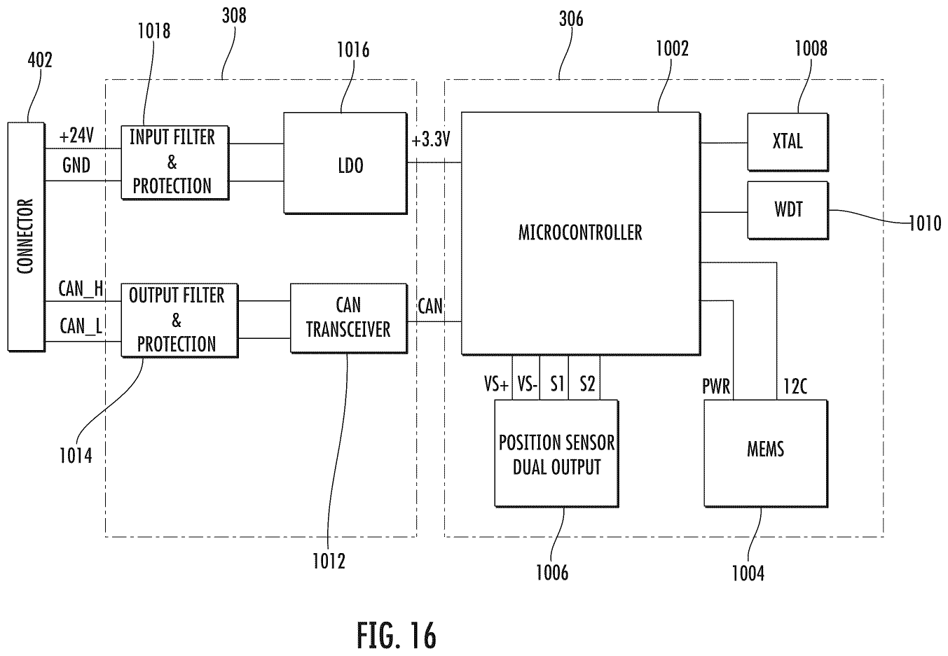

FIG. 16 illustrates a block diagram of the components of the position sensor 106, in accordance with an example embodiment of the present disclosure. As shown, the position sensor 106 has the data sensor 306, the communication sensor 308 and the connector 402. The data sensor 306 comprises a microcontroller 1002, an inclination sensing unit (MEMS) 1004, a swing angle sensing unit 1006, also referred to as a position sensor dual output, Crystal Oscillator (XTAL) pins 1008 and Watch dog timer (WDT) 1010. In an example, the input terminals of the inclination sensing unit 1004 is connected to output terminals of the accelerometer and the gyroscope (not shown in the figures). The input terminals of the swing angle sensing unit 1006 is connected to the sensor elements. The XTAL pins 1008 are external oscillator used to keep clocking for the microcontroller 1002. The WDT 1010 can be understood as an on-chip oscillator which does not require any external components.

The communication sensor 308 comprises a CAN transceiver 1012, an output filter and protection 1014, a Low Dropout Regulator (LDO) 1016, and an input filter and protection 1018. The CAN transceiver 1012 is configured to receive and transmit communication packets to and from the data sensor 306. The output filter and protection 1014 and the input filter and protection 1018 are used for filtering communication packets before transmitting or receiving the communication packets to enhance efficiency of the transmission of communication packets. The LDO 1016 can maintain a specified output voltage over a wide range of load current and input voltage, down to a very small difference between input and output voltages. This aids in voltage stability during operation of the communication sensor 308.

During operation, in an instance when the cabin 102 rotates or changes position with respect to the wheels or the ground, the magnet 602 coupled to the cabin 102 rotates. The rotation of the magnet 602 causes the magnetic field of the magnet 602 to change. The change in the magnetic field of the magnet 602 is detected by the sensor elements on the data sensor 306 as change in voltage. The change in voltage is provided to the swing angle sensing unit 1006. The swing angle sensing unit 1006 receives the data, processes it and sends the processed data to the microcontroller 1002.

The position sensor 106 is also coupled to a gyroscope and an accelerometer. In an instance when the cabin 102 tilts with respect to the horizontal plane h, the gyroscope and the accelerometer detect the inclination of the position sensor 106 and send a signal to the inclination sensing unit (MEMS) 1004 of the data sensor 306. The inclination sensing unit (MEMS) 1004 receives the signal, processes the signal and sends data corresponding to the inclination of the position sensor 106 to the microcontroller 1002.

The microcontroller 1002 receives the data related to the swing angle from the swing angle sensing unit 1006 and the inclination from the inclination sensing unit (MEMS) 1004. The microcontroller 1002 processes the data and combines the data and sends the combined data to the CAN transceiver 1012 of the communication sensor 308. The CAN transceiver 1012 then converts the combined data into a CAN packet and sends the data to the connector 402 for transmitting to the ECU. The ECU processes the packet and determines the actual position and alignment of the cabin 102.

It must be noted that, as used in this specification and the appended claims, the singular forms “a,” “an,” and “the” include plural referents unless the content clearly dictates otherwise.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments, but not other embodiments.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present disclosure are disclosed herein; however, it is to be understood that the disclosed embodiments are merely exemplary, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

While it is apparent that the illustrative embodiments herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present disclosure.

What is claimed is:

1. A sensor assembly for a position sensor, comprising:
a data sensor comprising a first printed circuit board, wherein the first printed circuit board has a plurality of sensor elements disposed on a first side of the first printed circuit board, wherein the first printed circuit board comprises:
a plurality of hall sensors; and
a swing angle sensor;
a communication sensor electrically connected to the data sensor, the communication sensor comprising a second printed circuit board;
a first housing defining a cavity of the first housing, wherein the data sensor and the communication sensor are disposed within the cavity of the first housing, and wherein the first housing comprises a first portion and a second portion;
a second housing defining a first cavity of the second housing, wherein the second portion of the first housing is housed within the first cavity of the second housing; and
a magnet disposed in the first cavity of the second housing and coupled to a rotatable component of a heavy machine, wherein the magnet is rotatable along a rotational axis, and wherein:
the plurality of hall sensors is configured to detect change in magnetic flux of the magnet as a change in voltage in response to rotation of the magnet,
the swing angle sensor processes data corresponding to the change in voltage and sends the processed data to a microcontroller,
the microcontroller receives the data from the swing angle sensor and an inclination sensor, processes the data, and combines the data, and
the communication sensor converts the combined data into a CAN packet for transmission to an Engine Control Unit (ECU) for determining position and alignment of the rotatable component.

2. The sensor assembly of claim 1, wherein the second printed circuit board faces a second side of the first printed circuit board.

3. The sensor assembly of claim 1, wherein the first printed circuit board comprises the inclination sensor electrically connected with at least one of a gyroscope and an accelerometer to detect inclination of the position sensor.

4. The sensor assembly of claim 3, wherein the inclination sensor sends data corresponding to the inclination of the position sensor to the microcontroller.

5. The sensor assembly of claim 1, wherein the inclination sensor comprises a mems sensor.

6. The sensor assembly of claim 1, wherein the swing angle sensor is configured to detect at least one of a yaw rotation angle and a roll angle of a cabin of a heavy machine.

7. The sensor assembly of claim 1, wherein the communication sensor comprises a Controller Area Network (CAN) transceiver to receive data from the data sensor.

8. The sensor assembly of claim 1, wherein the communication sensor further comprises a filter.

9. The sensor assembly of claim 1, wherein the sensor assembly is electrically connected to the Engine Control Unit (ECU).

10. A sensor assembly for a position sensor, the sensor assembly comprising:
a first housing defining a cavity of the first housing, the first housing comprises a first portion and a second portion;
a data sensor disposed within the cavity of the first housing, the data sensor comprising,
a first printed circuit board, wherein the first printed circuit board has a plurality of sensor elements disposed on a first side of the first printed circuit board, wherein the first printed circuit board comprises:
a plurality of hall sensors; and
a swing angle sensor;
a communication sensor disposed within the cavity of the first housing and electrically connected to the data sensor, the communication sensor comprising:
a second printed circuit board, wherein the second printed circuit board faces a second side of the first printed circuit board;
a second housing defining a first cavity of the second housing, wherein the second portion of the first housing is housed within the first cavity of the second housing; and
a magnet disposed in the first cavity of the second housing and coupled to a rotatable component of a heavy machine, wherein the magnet is rotatable along a rotational axis, and wherein:
the plurality of hall sensors is configured to detect change in magnetic flux of the magnet as a change in voltage in response to rotation of the magnet,
the swing angle sensor processes data corresponding to the change in voltage and sends the processed data to a microcontroller,
the microcontroller receives the data from the swing angle sensor and an inclination sensor, processes the data, and combines the data, and
the communication sensor converts the combined data into a CAN packet for transmission to an Engine Control Unit (ECU) for determining position and alignment of the rotatable component.

11. The sensor assembly as claimed in claim 10, wherein the first printed circuit board comprises the inclination sensor electrically connected with at least one of a gyroscope and an accelerometer to detect inclination of the position sensor, and wherein the inclination sensor sends data corresponding to the inclination of the position sensor to the microcontroller.

12. The sensor assembly as claimed in claim 10, wherein the inclination sensor comprises a mems sensor.

13. The sensor assembly as claimed in claim 10, further comprising a connector disposed within the cavity of the first housing.

14. The sensor assembly of claim 10, wherein the swing angle sensor detects at least one of a yaw rotation angle and a roll angle of a cabin of a heavy machine.

15. A position sensor for detecting swing and inclination for a cabin of a heavy machine, the position sensor comprising:
a first housing defining a cavity of the first housing, the first housing comprises a first portion and a second portion;
a data sensor disposed within the cavity of the first housing, the data sensor comprising,
a first printed circuit board, wherein the first printed circuit board has a plurality of sensor elements disposed on a first side of the first printed circuit board, wherein the first printed circuit board comprises:
a plurality of hall sensors; and
a swing angle sensor;
a communication sensor disposed within the cavity of the first housing and electrically connected to the data sensor, the communication sensor comprising:
a second printed circuit board, wherein the communication sensor is disposed within the cavity of the first housing;
a second housing coupled to the first housing, wherein the second housing defines a first cavity of the second housing, and wherein the second portion of the first housing is housed within the first cavity of the second housing; and
a magnet rotatable about a rotational axis, disposed within the first cavity of the second housing, wherein the magnet is coupled to the cabin and rotates in an instance when the cabin rotates, wherein a first end of the magnet is disposed adjacent to the data sensor, and
wherein:
the plurality of hall sensors is configured to detect change in magnetic flux of the magnet as a change in voltage in response to rotation of the magnet,
the swing angle sensor processes data corresponding to the change in voltage and sends the processed data to a microcontroller,
the microcontroller receives the data from the swing angle sensor and an inclination sensor, processes the data, and combines the data, and
the communication sensor converts the combined data into a CAN packet for transmission to an Engine Control Unit (ECU) for determining position and alignment of the cabin.

16. The position sensor as claimed in claim 15, wherein the second housing comprises a second cavity of the second housing, wherein the first housing is disposed within the second cavity of the second housing.

17. The position sensor as claimed in claim 15, wherein the second printed circuit board faces a second side of the first printed circuit board.

18. The position sensor as claimed in claim 15, wherein the swing angle sensor detects at least one of a yaw rotation angle and a roll angle of the cabin of the heavy machine.

19. The position sensor as claimed in claim 15, wherein the first printed circuit board comprises the inclination sensor electrically connected with at least one of a gyroscope and an accelerometer to detect inclination of the position sensor, and wherein the inclination sensor sends data corresponding to the inclination of the position sensor to the microcontroller.

20. The position sensor as claimed in claim 15, wherein the inclination sensor comprises a mems sensor.
